(19) United States
(12) Patent Application Publication
(10) Pub. No.: US 2006/0087913 A1
(43) Pub. Date: Apr. 27, 2006

(54) Rotary mixer

(76) Inventor: Chong Kok Leong, Puchong (MY)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/972,194

(22) Filed: Oct. 22, 2004

(51) Int. Cl. B01F 7/16

(52) U.S. Cl. 366/206; 366/601; 366/279; 366/286; 366/203

(57) ABSTRACT

A rotary mixer (1) has an electric drive motor (2) which drives a rotor (4) via an intermediate drive shaft (3). The motor, preferably an induction motor, is powered from a variable frequency supply by which the speed of the motor can be varied. In one option, support arms (20) carry a bearing (30) which supports the distal end of the drive shaft. The arms may also support an optional stator (35) in a position surrounding the rotor. Connections between the motor, drive shaft and rotor, and between the motor body, support arms and bearing or stator, are made by screw threads (10, 11, 12, 21, 22, 33, 34) to facilitate easily assembly and disassembly of the ‘wetted’ mixer components without the use of tools. The rotor has blades, the tips of which have a V-shaped transverse cross-section which can co-operate with similarly V-shaped slits in a cylindrical wall of the optional stator.

### FIELD OF INVENTION

The present invention relates to powered rotary mixers and the like, as typically used in laboratory and industrial environments to process a wide range of fluid or semi-fluid materials including, but not limited to, liquids, liquid-based suspensions and slurries, and pastes.

### BACKGROUND OF THE INVENTION

Rotary mixers are used for a wide range of processes, for example stirring, mixing, blending, dispersing, and emulsifying in a broad range of laboratory and industrial and applications, for example in the development and manufacture of chemicals, coatings, paints and inks, adhesives, cosmetics and toiletries, beverages and foods, textiles, electronics, and pharmaceuticals. Such mixers are used in the manufacture of products such as creams, lotions, shampoo, toothpaste, hair dyes, syrups, ointments, flavoring, mayonnaise, mustard, emulsions, wax, lacquer, resin, epoxy, PU (polyurethane), silicone, hot melt, PSA (pressure sensitive adhesive), plastic, rubber, pigment dispersion.

Known mixers are restricted in their purpose or application to a single or limited function. For example, known mixers are not able to cover a range of functions, being limited to one of mixing, dispersing or emulsifying, for example.

Mixers conventionally use a DC drive motor with a commutator and carbon brushes. Sparks or arcs produced at the commutator-brush interface can be dangerous, particularly in a flammable environment such as when the mixer is used with volatile solvents, for example in the inks and paints industries.

Known mixers are often difficult to clean or sterilize. This can be particularly so where access to cavities and recesses that can harbor material being processed is restricted, and more so if disassembly of the mixer rotor and associated components is impossible or even difficult, or requires the use of tools.

### SUMMARY OF THE INVENTION

The object of at least one aspect of the present invention is to provide a rotary mixer that goes some way towards mitigating at least some of the above-mentioned problems associated with prior art mixers.

Another object of at least one aspect of the invention is to provide a mixer that is versatile, being readily adaptable to perform a range of different functions.

A further object of at least one aspect of the invention is to provide a mixer that may be readily disassembled without the use of tools to allow for cleaning and sterilizing.

Yet a further object of at least one aspect of the invention is to provide a rotary mixer with a controllable rotational speed.

Another object of at least one aspect of the present invention is to provide a rotor and/or stator for a rotary mixer to provide higher shear forces and flow rates than those provided by prior art mixers.

In broad terms a first aspect of the invention may be said to be a rotary mixer having an electric drive motor, a drive shaft and a rotor; where one end of the drive shaft is connected to the drive motor and the rotor is connected to the other end of the drive shaft, for rotation of the rotor by the motor via the intermediate drive shaft.

Preferably the drive motor is an induction motor, and optionally a 3 phase induction motor.

Preferably the drive motor is connected to a variable frequency electrical supply.

The variable frequency supply is either integrated with the drive motor or located remotely from the drive motor.

The rotational speed of the drive motor, the shaft and the rotor is preferably controlled by varying the frequency of the variable frequency supply.

Optionally, the drive shaft has respective screw threads at each end by which said one end of the drive shaft is coupled to the drive motor, and the rotor is connected to said other end of the drive shaft.

Optionally, the drive shaft has a tapered shoulder near said one end, the drive motor includes a coupling by which said one end of the drive shaft is connected to the drive motor, and the coupling has a screw thread and a tapered shoulder both of which are respectively complementary to the screw thread and shoulder at or near the one end of the drive shaft, whereby a tightened engagement of the screw thread at said one end of the drive shaft with the complementary screw thread of the drive motor coupling causes the respective tapered shoulders to mutually engage and bring the axis of the drive shaft into substantial alignment with the axis of the drive motor.

Preferably the direction of rotation of the drive motor and the handing of the screw threads by which the drive shaft is connected to the drive motor and by which the rotor is connected to the drive shaft are such as to tend to tighten the screw threaded connections between the motor and drive shaft and between drive shaft and rotor when the motor rotates the rotor against the resistance of fluid being processed by the mixer.

Optionally, the shaft is rotatable in a bearing which is supported by at least one arm one end of which is rigidly connected to a stationary part of the drive motor.

Preferably the mixer includes a pair of said arms located diametrically opposite one another on either side of the drive shaft.

Optionally, the mixer includes a stator which is connected to the distal end of each said arm and is located to surround and co-operate with the rotor.

Preferably the mixer includes a holder which is connected to the distal end of each arm, and the stator and holder have complementary screw threads by which the stator is connected to the holder.

Preferably the direction of rotation of the drive motor and the handing of the screw threads by which the stator is connected to the holder are such that the rotor when driven causes fluid being processed by the mixer to be rotated in a direction that tends to tighten the screw threaded connection between the stator and holder.

In broad terms a second aspect of the invention may be said to be a rotor having a plurality of blades each of which extend radially outward from a central hub, wherein the outer end portion of each blade has a V-shaped transverse cross-section.

The V-shaped cross-section of each blade is preferably oriented so that the apex of the V-shape is directed, in use, oppositely to the direction of rotor rotation.

In broad terms a third aspect of the invention may be said to be a stator for a rotary mixer, the stator having a circularly cylindrical wall which is perforated by a plurality of slits, wherein each slit has at least a portion that is aligned not parallel to the axis of the cylindrical stator wall. Preferably each stator slit is substantially straight and the slits are linked in pairs to form a series of V-shaped slit pairs.

More preferably, the V-shaped slit pairs are circumferentially arrayed about the stator wall, and bisectors of the included angles between the slits of each V-shaped pair lie substantially in a common plane to which the axis of the cylindrical stator wall is substantially perpendicular.

In broad terms a fourth aspect of the invention may be said to be a rotor/stator combination for a rotary mixer, including the rotor of the second aspect of the invention and any of its preferences or options, and the stator of the third aspect of the invention and any of its preferences or options.

Preferably, in the fourth aspect, the apexes of the V-shapes of the cross-sections of the outer end portions of the rotor blades and the bisectors of the included angles between the slits of each V-shaped pair of stator slits lie substantially on the same common plane.

In broad terms a fifth aspect of the invention may be said to be the rotary mixer of the first aspect of the invention and any of its preferences or options, wherein the rotor is the rotor of the second aspect of the invention and any of its preferences or options.

In broad terms a sixth aspect of the invention may be said to be the rotary mixer of the first aspect of the invention and any of its preferences or options, including the stator of the third aspect of the invention and any of its preferences or options.

The invention may further be said to consist in any alternative combination of parts or features mentioned herein or shown in the accompanying drawings. Known equivalents of these parts or features which are not expressly set out are nevertheless deemed to be included.

These and other objects, advantages and features of the invention will be more readily understood and appreciated by reference to the detailed description of the drawings.

### BRIEF DESCRIPTION OF THE DRAWINGS

It will be appreciated that a rotary mixer may be implemented in various forms. Preferred embodiments of the invention will now be described, by way of example only and without intending to be limiting, with reference to the accompanying drawings of which:

FIG. 1 shows a front elevation of a rotary mixer according to one aspect of the current invention;

FIG. 2 shows partly-sectioned front elevation of the rotary mixer shown in FIG. 1 mounted on an optional support stand and connected to an optional remote variable frequency supply;

FIG. 3 shows a side elevation of the rotary mixer shown in FIG. 2 mounted on the support stand and connected to the variable frequency supply;

FIG. 4 shows a top plan view of the rotary mixer shown in FIGS. 2 and 3, mounted on the support stand but not connected to the optional variable frequency supply;

FIG. 5 is an exploded view showing some components of one embodiment of a rotary mixer according to one aspect of the current invention;

FIG. 6A is a plan view of a rotary mixer rotor according to another aspect of the current invention;

FIG. 6B is a side elevation of the rotor shown in FIG. 6A;

FIG. 7A is a plan view of a second rotary mixer rotor;

FIG. 7B is a side elevation of the rotor shown in FIG. 7A;

FIG. 8A is a plan view of a rotary mixer stator according to yet another aspect of the current invention;

FIG. 8B is a cross-sectional side view of the rotor as seen at line A-A′ in FIG. 8A; and

FIG. 8C is a side elevation of the stator shown in FIGS. 8A and 8B.

### DETAILED DESCRIPTION OF THE DRAWINGS

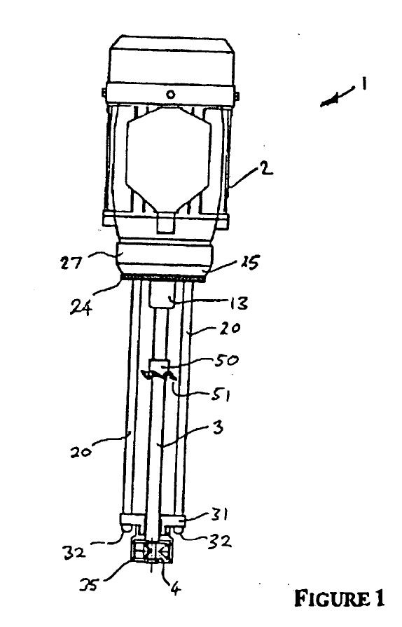

In the following description, various features are referred to by relative positions or orientations; for example, by terms such as “upper”, “lower” and “rearward”. These and similar references are given to aid in the understanding of the invention when the mixer is in the orientation shown in FIGS. 1 to 5. The invention may be conveniently used in this orientation, for example when the mixer is supported on a horizontal surface by the stand shown in FIGS. 2, 3 and 4. However, the invention is not limited to this particular orientation.

FIGS. 1 to 5 show a rotary mixer 1 having an electric drive motor 2 which is connected to one end of a drive shaft 3. The other end of the drive shaft is connected to a rotor 4. Operation of the drive motor rotates the rotor, via rotation of the intermediate drive shaft. The rotor is thus driven directly by the motor, i.e. without any intermediate belts, gearwheels or friction wheels. This avoids the potential for wear and tear, and the sequent costs of service and repair associated with these components as used in mixers of the prior art.

The drive motor is an AC induction motor and is preferably a three-phase induction motor. The use of an induction motor, rather then the conventional DC motor with commutator and brushes as used in prior art mixers, provides several advantages: the elimination of a significant cause of wear and breakdowns; a quieter running motor; and the elimination of the possibility of sparks or arcs from commutation which improves the safety of mixer operation in potentially flammable environments, e.g. with volatile solvents.

The drive motor is connected to a variable frequency supply 5 which may be integrally attached to or mounted within the drive motor body or housing 6.

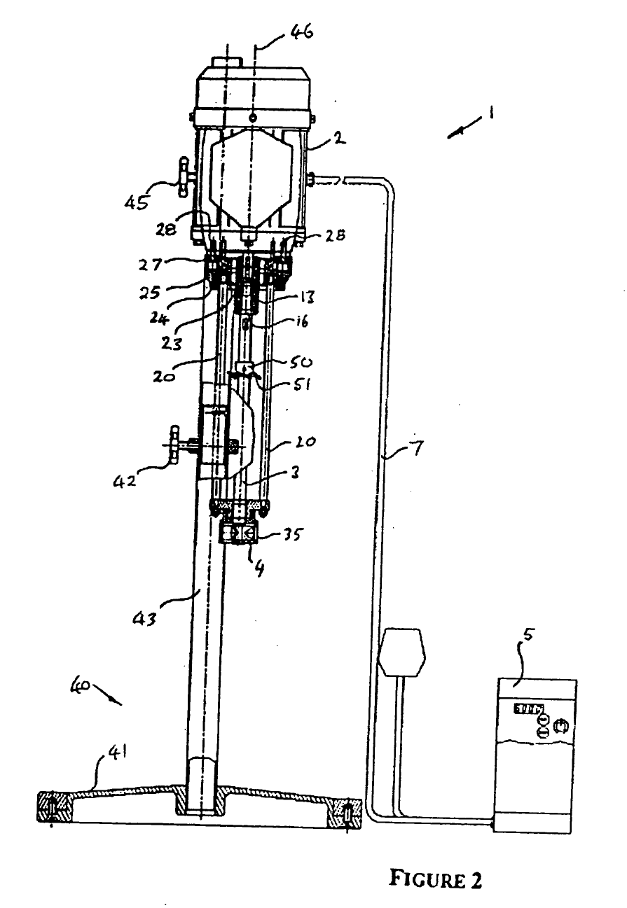

Alternatively, the variable frequency power supply may be located remotely from the drive motor as shown in FIGS. 2 and 3, in which case a flexible power cable 7 is used to connect the motor to the variable frequency supply. The weight of the drive motor is reduced by remotely locating the variable frequency supply away from the drive motor. This reduction lessens the weight that a user has to shift up or down when working the mixer. Separation of the supply from the mixer also enables operation of the mixer to be controlled semi-remotely, at the variable frequency supply. The separation of the supply from the mixer also reduces the possibility of contamination of the supply from materials being processed and from any associated vapors. Furthermore, separation of the supply from the mixer also allows easy replacement of the supply without any technical expertise.

The use of an AC induction motor driven by a variable frequency supply allows the motor to deliver 150% or more of its rated continuous torque. This provides the mixer with high starting torque and makes the mixer useful for processing high viscosity fluids.

The rotational speed of the induction drive motor, and thus the rotor, is varied by varying the frequency of the variable frequency supply. In a preferred embodiment the motor and rotor speed is variable over the range 0 to 6000 rpm. The combination of the frequency controlled supply and the induction drive motor provides stable operation speeds. The combination also provides stable operation speeds throughout the entire speed range, including low motor speeds and even when the loading on the motor is fluctuating, such as when more ingredients are being added to the mix.

The variable frequency supply is conveniently an electronic supply and can be an inverter by which power from a DC rail or DC supply is inverted into the variable frequency AC power that is then supplied to the drive motor. Power for the variable frequency supply, or its DC rail or DC supply, is conveniently derived from an AC source such as a common household single-phase outlet, or from a three-phase industrial-style outlet.

The motor body or housing 6 is preferably made of aluminum or an aluminum alloy for light weight and for good heat dissipation. Heat dissipation may be further improved by the use of fins or ribs on the motor body or housing 6 to increase its external surface area.

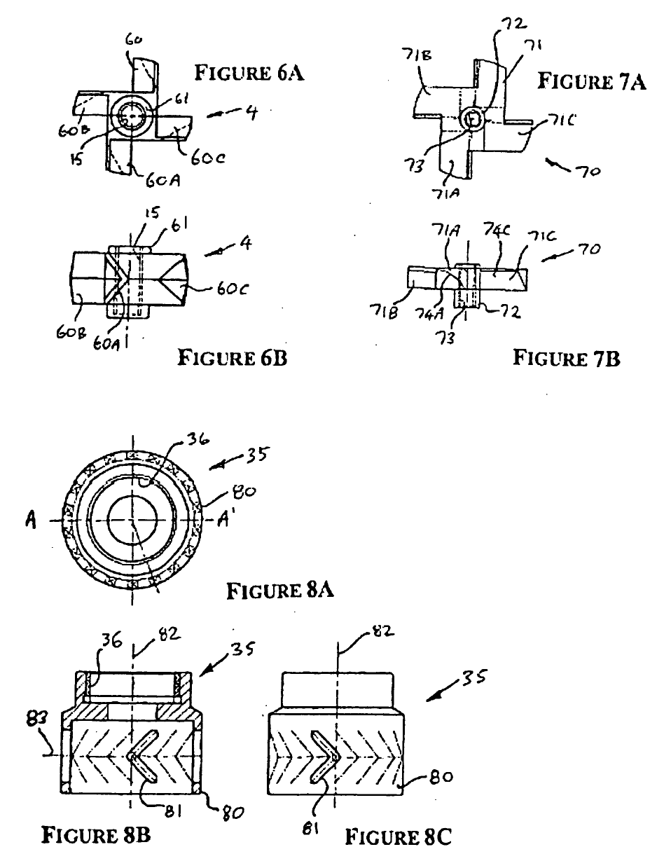

As may be best appreciated from FIG. 5, the drive shaft 3 has respective screw threads 10, 11 at its upper and lower ends. The drive shaft is connected to the motor by screwing the thread 10 at the upper end of the drive shaft into a threaded bore 12 of a collar or coupler 13, the upper end of which is attached to the shaft 14 of the drive motor. The rotor 4, which, as will be explained further below in relation to FIGS. 6A and 6B, has a threaded bore 15. The rotor is connected to the lower end of the drive shaft by screwing the threaded rotor bore 15 onto the thread 11 at the lower end of the drive shaft 3.

The drive shaft 3 has a tapered shoulder 16 (as may be seen in FIGS. 2 and 5) near the thread 10 at the upper end of the drive shaft. The lower end of the bore 12 in the coupler 13 has a complementary tapered shoulder 17 (as may be best seen in FIG. 5). The two tapered shoulders engage one another when the upper end of the drive shaft 3 is screwed tightly into the coupler 13 to bring the drive shaft into close axial alignment with the shaft 14 of the motor.

The handing of the screw threads are such that operation of the mixer tends to tighten rather than loosen the threaded couplings between the motor coupler 13 and the upper end of the drive shaft 3, and between the lower end of the drive shaft 3 and the rotor 4. For example, in the preferred embodiment, the drive motor rotates clockwise as seen when looking down at the motor from a view point above the motor, and the screw threads in the bore 12 of the motor coupler 13, on each end of the drive shaft 3, and in the rotor bore 15 are all right hand threads. When the motor rotates the rotor against the resistance of fluid being processed by the mixer, this relationship between the direction of drive motor rotation and the handing of the threads tends to tighten the threaded connections.

The mixer shown in FIGS. 1 to 5 has a pair of stabilizer arms 20. The arms are rigidly 20 connected at their upper ends to the body or other stationary part of the motor. The two arms 20 are diametrically located on opposite sides of the drive shaft 3. As may be best appreciated from FIG. 5, the upper ends of the arms have respective screw threads 21 by which the arms 20 screwed into complementarily threaded holes 22 in an annular plate 23. The annular plate is clamped between a lock ring 24 and a mounting plate 25. The lock ring 24 and mounting plate 25 have complementary screw threads by which these two components are screwed together to clamp the annular plate there-between. The lock ring 24 has a knurled outer surface to provide for easy grip of the ring when assembling and disassembling the mixer. The mounting plate 25 is fastened by four countersunk-headed screw fasteners 26 to the underside of drive motor mounting bracket 27. Four screw fasteners 28 (seen in FIG. 2 but not shown in FIG. 5) fasten the drive motor 2 to the mounting bracket 27.

The lower end of the drive shaft 3 rotates in a supporting bush or bearing 30 which is carried in a holder 31. The holder 31 is attached to the lower end of the arms 20 by engagement of threaded nuts 32 on screw threads 33 provided at the lower end of each arm. The holder 31 is rigidly connected to the stationary part of the drive motor 2 to provide a stabilizing support for the lower, i.e. distal, end of the drive shaft 3 and the rotor 4 attached thereto.

The holder 31 has a screw thread 34 by which a stator 35, with a complementarily threaded bore 36 (as may be best appreciated from FIG. 8B), is attached to the holder.

The stator 35 is located so as to concentrically surround and co-operate with the rotor 4 which is attached to the lower, i.e. distal, end of the drive shaft 3. The close proximity of the attachment of the stator 35 to the holder 31, and the support provided by the holder 31 and bearing 30 to the rotor 4, helps maintain a close tolerance between the stator and rotor.

The handing of the screw threads is such that operation of the mixer tends to tighten rather than loosen the threaded attachment of the lock ring 24 to the mounting plate 25 and of the stator 35 to the holder 31. For example, in the preferred embodiment, the drive motor rotates clockwise as seen when looking down at the motor from a view point above the motor, and the screw threads on the lock ring 24 and on the mounting plate 25, and the screw thread 34 on the holder 31 and the thread in the stator bore 36 are all left hand threads. When the motor drives the rotor 4 to rotate the fluid being processed by the mixer 1 against the resistance provided by the stationary stator 35, this relationship between the direction of drive motor rotation and the handing of the threads, tends to tighten these threaded connections.

Although the embodiment shown in FIGS. 1 to 5 has two arms 20, it is envisaged that any other suitable number of such arms may be used. For example, there may be one or three such arms 20 to carry the bush or bearing 30 and the stator 35. In the case of multiple arms 20, it is preferred that they be evenly circumferentially arrayed about the drive shaft 3.

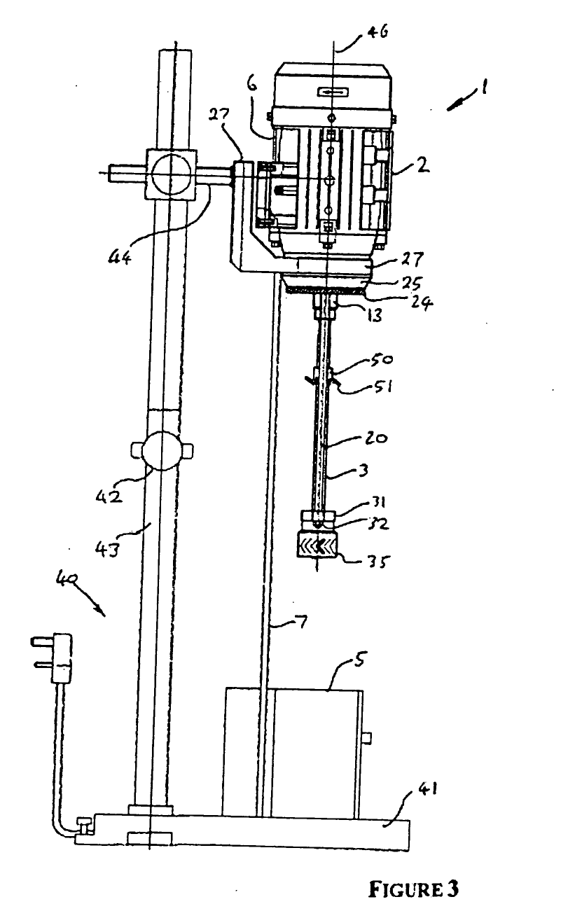

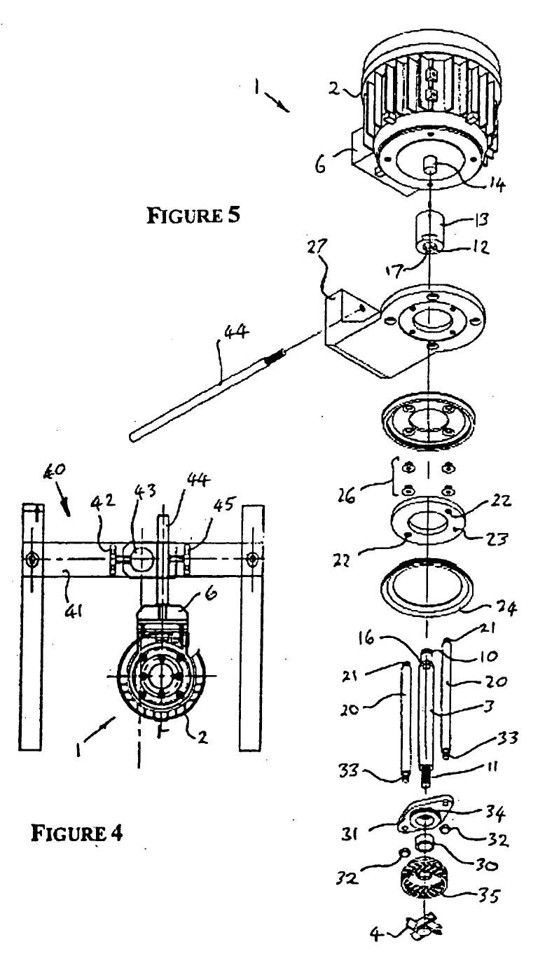

The drive motor mounting bracket 27 may be attached to an optional support stand 40, shown in FIGS. 2, 3 and 4. The stand has a three-segment platform or foot 41 formed in an H-shape, as may be best appreciated from the plan view of FIG. 4. A releasable clamp 42 on a vertical tubular portion 43 of the stand 40 permits the height of the mixer above the foot to be adjusted.

A rod 44 extends rearward from the mounting bracket 27 and is connected to the vertical stand portion 43. A releasable clamp 45 at the connection between the rod 44 and the vertical stand portion 43 permits adjustment of the horizontal offset of the mixer 1 from the vertical stand portion 43 and the angle of the axis 46 of the mixer drive shaft 3 relative to a vertical axis.

The mixer optionally includes a secondary rotor 50 which is attached to an intermediate portion of the drive shaft 3 as shown in FIGS. 1, 2 and 3. The secondary rotor has a plurality of vanes 51. This secondary rotor can be used to augment the circulation of the material being processed by the mixer.

One preferred rotor 4 is shown in FIGS. 6A and 6B, and also in perspective view in FIG. 5, and in side elevation in the partly cross-sectioned FIGS. 1 and 2, where cross-sectioning of the stator 35 reveals the rotor. The rotor 4 has four blades 60 which extend radially outward from a central hub 61. The outer end portion of each blade has a V-shaped cross-section as may be best appreciated from FIG. 6B which shows the V-shaped end tip of one blade 60A. The rotor is designed to rotate with the apex of the V-shaped blade tip directed against the direction of rotation. In other words, the rotor shown in a top plan view in FIG. 6A rotates clockwise, and blade 60A will move from right to left as seen in the side elevation of FIG. 6B. FIG. 6B thus shows the trailing face of blade 60B and the leading face of blade 60C.

An alternative rotor 70 is shown in FIGS. 7A and 7B. This rotor has four blades 71 30 which extend radially outward from a central hub 72. The central hub has a threaded bore 73 by which the rotor 70 can be attached to the thread 11 at the distal end of the mixer drive shaft 3. Each blade has a curved leading and lower face 74 as may be best appreciated from FIG. 7B which shows an end view of the curved face 74A of one blade 71A. The rotor 70 is designed to rotate clockwise as seen in the top view shown in FIG. 7A, and blade 71A will therefore move from right to left as seen in the side elevation of FIG. 7B. FIG. 7B thus shows the trailing face of blade 71B and the curved leading face 74C of blade 71C.

Although rotors with four blades are described above, any other suitable number of blades may be used; for example, one, two, three, five or six, and rotors with other blade shapes may be used.

One preferred stator 35 is shown in perspective view in FIG. 5, and in side elevation in FIG. 3, and in more detail in FIGS. 8A, 8B and 8C. At one axial end of the stator 35 has there is a circularly cylindrical wall 80 which is perforated by a plurality of slits 81. Each slit has at least a portion that is aligned in a direction that is not parallel to the axis 82 of the cylindrical stator wall 80. In this preferable embodiment, the slits are straight and are arranged in pairs of slits, the two slits of each pair intersecting one another in a V-shaped configuration. The V-shaped slit pairs are arrayed about the cylindrical stator wall. The bisectors of the included angles between the slits of each V-shaped pair lie in a common plane 83. The axis 82 of the cylindrical stator wall is substantially perpendicular to this common plane.

At the other axial end of the stator there is a threaded bore 36 by which the stator is attached to the holder 31 at the lower end of the arms 20. In the case of a mixer 1 as shown in FIGS. 1 to 5, which uses a rotor 4 shown in detail in FIGS. 6A and 6B, and a stator 35 as shown in detail in FIGS. 8A, SB and SC, the leading face of each blade 60 is formed as a scoop which engages and rotates material being processed by the mixer. The rotating material undergoes mechanical shearing at the close gap between the stator and rotor and is forced by centrifugal action radially outward and through the slits 81 in the cylindri3al wall 80 of the stator. As the material being processed is forced outward through the stator, hydraulic and cavitation shear forces are created in addition to turbulent and laminar shears. As the speed is increased, so does the shearing forces. This provides an intensive mixing action and fine grinding.

The relative positions of the rotor 4 and stator 35 are such that the apexes of the V-shapes of the cross-sections of the outer end portions of the rotor blades 60 lie in the same plane 83 in which the bisectors of the included angles between the slits 81 of each V-shaped pair of stator slits lie.

The oblique angle of the stator slits 81 expose the material being processed by the mixer 10 to a longer cutting or shearing edge than the conventional vertical slots of the prior art mixers. This is enhanced by the similarly oblique arms of the V-shape of the rotor blades 60. Use of the stator 35 in combination with the rotor 4 increases the shearing force and the flow rate of material being processed, over those of prior art mixers. The increased flow rate helps to reduce heat generation in the material being processed, and also the likelihood of “fish eyes”.

The mixer and its associated components as described herein can provide smaller particle sizes (about I to 50 micron, compared to about 300 to 500 micron), and faster processing times and improved homogeneity than conventional dispersers and mixers.

The mixer as described above is a multi-use tool that can be used with a range of interchangeable rotors and stators, or even without a stator, to provide a range of different processing functions, such as stirring, mixing, dispersing, emulsifying, and the like.

The “wetted” components of the mixer, i.e., those that are to be immersed in, or otherwise in contact with, material being processed, are preferably made from 316L grade stainless steel or, in the case of the bush or bearing 30, from Teflon or bronze. Alternatively, the mixer components made be made from any other suitable material, e.g., one that is not incompatible with the material to be processed by the mixer.

The screw threaded attachments described above not only allow the mixer components to be interchanged allowing the mixer to perform multiple processing functions, they also allow the mixer components to be quickly and easily assembled for use and then dismantled for cleaning and sterilization, all without tools. This ease of assembly and disassembly is important, particularly in the pharmaceutical, food, beverage and cosmetic industries where standards of Good Manufacturing Practice (GMP) are highly specified. The ease of assemble and disassembly of the mixer of the current invention is in contrast to many prior art mixers which cannot be fully dismantled, or require hand tools to assemble or dismantle mixer components.

The foregoing describes the invention including preferred forms thereof. Alterations and modifications as will be obvious to those skilled in the art are intended to be incorporated within the scope of the invention as defined in the accompanying claims.

It is to be understood that the numerical references included in parentheses in the following claims are given merely as a guide in understanding the correspondence between integers of the claims and the features of the exemplary but non-limiting embodiments shown in the figures. The claims are not intended to be limited to the features or arrangements as shown in the figures.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A rotary mixer (1) having an electric drive motor (2), a drive shaft (3) and a rotor (4); where one end of the drive shaft is connected to the drive motor and the rotor is connected to the other end of the drive shaft, for rotation of the rotor by the motor via the intermediate drive shaft.

2. The rotary mixer as claimed in claim 1, wherein the drive motor is an induction motor.

3. The rotary mixer as claimed in claim 1, wherein the drive motor is a 3 phase induction motor.

4. The rotary mixer as claimed in claim 2 or 3, wherein the drive motor is connected to a variable frequency electrical supply (5).

5. The rotary mixer as claimed in claim 4, wherein the variable frequency supply is integrated with the drive motor, the variable frequency supply being either attached to the drive motor or included with the drive motor in a common housing (6).

6. The rotary mixer as claimed in claim 4, wherein the variable frequency supply is located remotely from the drive motor.

7. The rotary mixer as claimed in claim 4, 5 or 6, wherein the rotational speed of the drive motor, the shaft and the rotor is controlled by varying the frequency of the variable frequency supply.

8. The rotary mixer as claimed in any one of the preceding claims, wherein the drive shaft has respective screw threads (10, 11) at each end by which said one end of the drive shaft is coupled to the drive motor, and the rotor is connected to said other end of the drive shaft.

9. The rotary mixer as claimed in claim 8, wherein the drive shaft has a tapered shoulder (16) near said one end, the drive motor includes a coupling (13) by which said one end of the drive shaft is connected to the drive motor, and the coupling has a screw thread (12) and a tapered shoulder (17) both of which are respectively complementary to the screw thread (10) and shoulder (16) at or near the one end of the drive shaft, whereby a tightened engagement of the screw thread at said one end of the drive shaft with the complementary screw thread of the drive motor coupling causes the respective tapered shoulders to mutually engage and bring the axis of the drive shaft into substantial alignment with the axis of the drive motor.

10. The rotary mixer as claimed in claim 8 or 9, wherein the direction of rotation of the drive motor and the handing of the screw threads by which the drive shaft is connected to the drive motor and by which the rotor is connected to the drive shaft are such as to tend to tighten the screw threaded connections between the motor and drive shaft and between drive shaft and rotor when the motor rotates the rotor against the resistance of fluid being processed by the mixer.

11. The rotary mixer as claimed in any one of the preceding claims, wherein the shaft is rotatable in a bearing (30) which is supported by at least one arm (20) one end of which is rigidly connected to a stationary part of the drive motor.

12. The rotary mixer as claimed in claim 11, wherein the mixer includes a pair of said arms (20) located diametrically opposite one another on either side of the drive shaft.

13. The rotary mixer as claimed in claim 11 or 12, wherein the mixer includes a stator (35) which is connected to the distal end of the or each said arm and is located to surround and co-operate with the rotor.

14. The rotary mixer as claimed in claim 13, wherein the mixer includes a holder (31) which is connected to the distal end of the or each arm, and the stator and holder have complementary screw threads (36, 34) by which the stator is connected to the holder.

15. The rotary mixer as claimed in claim 14 wherein the direction of rotation of the drive motor and the handing of the screw threads by which the stator is connected to the holder are such that the rotor when driven causes fluid being processed by the mixer to be rotated in a direction that tends to tighten the screw threaded connection between the stator and holder.

16. A rotor for a rotary mixer, wherein the rotor (4) has a plurality of blades (60) each of which extend radially outward from a central hub (61), and the outer end portion of each blade has a V-shaped transverse cross-section.

17. A rotor as claimed in claim 16, wherein the V-shaped cross-section of each blade is oriented so that the apex of the V-shape is directed, in use, oppositely to the direction of rotor rotation.

18. A stator for a rotary mixer, wherein the stator (35) has a circularly cylindrical wall (80) which is perforated by a plurality of slits (81), and each said slit has at least a portion that is aligned not parallel to the axis (82) of the cylindrical stator wall.

19. A stator as claimed in claim 18, wherein each said slit is substantially straight and the slits are linked in pairs to form a series of V-shaped slit pairs.

20. A stator as claimed in claim 19, wherein said V-shaped slit pairs are circumferentially arrayed about the stator wall, and bisectors of the included angles between the slits of each V-shaped pair lie substantially in a common plane (83) to which the axis (82) of the cylindrical stator wall is substantially perpendicular.

21. A rotor/stator combination for a rotary mixer, including a rotor as claimed in claim 16 or 17 and a stator as claimed in claim 18, 19 or 20.

22. A rotor/stator combination for a rotary mixer, including a rotor as claimed in claim 17 and a stator as claimed in claim 20, wherein the apexes of the V-shapes of the cross-sections of the outer end portions of the rotor blades and the bisectors of the included angles between the slits of each V-shaped pair of stator slits lie substantially on the same common plane.

23. A rotary mixer as claimed in any one of claims 1 to 15, wherein the rotor is a rotor as claimed in claim 16 or 17.

24. A rotary mixer as claimed in any one of claims 13, 14 or 15, wherein the stator is a stator as claimed in claim 18, 19 or 20.
